(19) United States
(12) Patent Application Publication
(10) Pub. No.: US 2017/0008810 A1
(43) Pub. Date: Jan. 12, 2017

(54) METHODS FOR PRODUCING CONCRETE HAVING IMPROVED CRACK RESISTANCE

(71) Applicant: Premier Magnesia, LLC, West Conshohocken, PA (US)

(72) Inventors: Jerry E. Rademan, Atlanta, GA (US); James Preskenis, Dover, DE (US)

(21) Appl. No.: 14/791,683

(22) Filed: Jul. 6, 2015

(51) Int. Cl. C04B 40/00

(52) U.S. Cl. CPC C04B 40/0042; C04B 40/0046

(57) ABSTRACT

Methods for forming concrete mixed having improved crack resistance are provided. According to one embodiment, the method may include providing a shrinkage reduction admixture. The method may also include providing a shrinkage compensating additive. The method may also include providing concrete solids. The method may further include mixing the shrinkage reduction admixture, the shrinkage compensating additive, and the concrete solids.

### TECHNICAL FIELD

This disclosure relates to concrete formulation and mixing, and more particularly relates to method for producing concrete having improved crack resistance.

### BACKGROUND

The proper incorporation of admixtures, or additives, into concrete mix designs is important in determining just how effective that admixture performs its intended functions within the placed concrete matrix. Most commonly used concrete admixtures are liquids which are carefully metered and pumped into the ready mix concrete materials, after the ready mix concrete materials have been weighed, as they are discharging into the mixer. In the case of a truck mix batch plant, for example in which a central mixer may not be used, the liquid admixtures may be added in the same manner, either with the solid materials after they are weighed or as they are discharging into the mixer. For volumetric mixers the admixtures may be added into either the ready mix materials, like the fine aggregate, or into the water tank or water discharge line.

Solid powdered concrete admixtures may often be added into central mix, truck mix or volumetric batches, if a separate silo with proper automated metering devices to control the homogeneity of the powered admixtures within the concrete mix are employed. Powdered admixtures, however, are not always commonly used in concrete mix designs, so a separate silo is not always available due to cost, or for various other reasons. If a silo with automated feeder is not available, then powdered admixtures are often times manually added directly into the central mix drum concrete truck drum. Sometimes the powdered admixtures may be added using pulpable (or re-pulpable) paper bags, or water dissolvable polymer bags, which are intended to dissolve or break up during mixing. However, pulpable or dissolvable bags do not always perform as advertised and can potentially produce problems with the placed concrete. For example, pulpable or dissolvable bags that do not fully break down may result in unwanted “balls” in ready mix and central mix wet concrete. Additionally, there have been documented cases of the re-pulpable bags not repulping and leaving undesirable amounts of visible paper in the concrete structure.

Often times, ready mix concrete plants do not have or desire to add a new silo for a powdered admixture, as it may not be a commonly used component to their larger volume mix designs. They therefore will prefer to find alternative methods of incorporating a powdered admixture without the use of a separate silo. They also just may add the powdered admixture into the concrete truck mixer either before or after loading the concrete materials. They would then add water to the truck and mix the concrete during its transport to the job site. This methodology does not always guaranty that the post added admixture is properly and homogeneously mixed. Therefore, alternate methods of incorporation are desirable to assure this admixture performs as required in the finished, placed concrete.

### SUMMARY OF THE DISCLOSURE

According to an implementation, a method of forming concrete having improved the crack resistance may include providing a shrinkage reduction admixture. The method may also include providing a shrinkage compensating additive. The method may also include providing concrete solids. The method may further include mixing the shrinkage reduction admixture, the shrinkage compensating additive, and the concrete solids.

One or more of the following features may be included. Providing the shrinkage reduction admixture may include pre-combining the shrinkage reduction admixture with concrete mix water, prior to combining the concrete mix water with the concrete solids. Pre-combining the shrinkage reduction admixture with the concrete mix water may produce one or more of an aqueous solution, a dispersion, and a suspension. Providing the shrinkage compensating additive may include combining the shrinkage compensating additive with the pre-combined shrinkage reduction admixture and concrete mix water, prior to combining the concrete mix water with the concrete solids. Providing the shrinkage compensating additive may include at least partially hydrating the shrinkage compensating additive with the concrete mix water. At least partially hydrating the shrinkage compensating additive may include mixing the shrinkage compensating additive and the concrete mix water for between about 0 minutes to about 30 minutes.

The shrinkage reduction admixture may include a surface tension reducing additive. The shrinkage reduction admixture may include one or more of a glycol ether, a polyglycol, a polypropylene glycol, a polyethylene glycol, and a glycol ether derivative.

The shrinkage compensating additive may include one or more of magnesium hydroxide, magnesium oxide, calcium oxide, calcium silicate, calcium sulfa aluminate, magnesium silicate, and magnesium sulfa aluminate. The shrinkage compensating additive may include a low temperature calcined and reactive magnesium oxide calcined at a temperature in the range of between about 750° C. to about 1,200° C. The shrinkage compensating additive may include magnesium oxide having a mean particle size in the range from between about 10 micrometers to about 20 micrometers.

The concrete solids may include cement and one or more of course aggregate, fine aggregate, and pozzolan. Mixing the shrinkage reduction admixture, the shrinkage compensating additive, and the concrete solids may include mixing in one or more of a central mix process, a ready mix process, and a volumetric mix process. Mixing the shrinkage reduction admixture, the shrinkage compensating additive, and the concrete solids may produce one or more of a grout, a mortar, a structural concrete, and a non-structural concrete.

The method may further include mixing a super absorbent polymer with the shrinkage reduction admixture, the shrinkage compensating additive, and the concrete solids. The super absorbent polymer may include one or more of a cellulosic material, a fiber-based material, a starch, a polyacrylonitrile, a polyvinyl alcohol, a carboxymethyl cellulose, an isobutylene maleic anhydride, a polyacrylic, and a polyacrylamide includes as one or more of a single polymer, a co-polymer, a tertiary polymer, and a cross-linked polymer in an acrylic-acrylamide copolymer system neutralized with one or more of potassium, magnesium, and another alkali earth metal. Mixing the super absorbent polymer with the shrinkage reduction admixture, the shrinkage compensating additive, and the concrete solids may include pre-combining the shrinkage reduction admixture with concrete mix water, mixing the shrinkage compensating additive with the pre-combined shrinkage reduction admixture and concrete mix water, and mixing the super absorbent polymer with the mixed shrinkage reduction admixture, concrete mix water, and shrinkage compensating additive to form one or more of a slurry and a suspension prior to mixing with the concrete solids.

The method may further include mixing an early-age desiccation additive with the shrinkage reduction admixture, the shrinkage compensating additive, and the concrete solids, the early-age desiccation additive comprising one or more of a calcium stearate, a butyl stearate, a polymer stearate, a potassium methyl siliconate, and an organo-silicone derivative. The method may further include mixing one or more of a polycarboxylate derivative, a sulfonated melamine-formaldehyde condensate, a sulfonated naphthalene-formaldehyde condensate, and a modified lignosulfonate with the shrinkage reduction admixture, the shrinkage compensating additive, and the concrete solids.

The details of one or more implementations are set forth in the accompanying drawings and the description below. Other features and advantages will become apparent from the description, the drawings, and the claims.

### DETAILED DESCRIPTION OF EXAMPLE EMBODIMENTS

Consistent with the present disclosure, methods for incorporating various additives into concrete mixes are disclosed. In some particular embodiments, the present disclosure may relate to methods for incorporating powdered shrinkage compensating additives, which may include, for example, magnesium oxide (MgO), into concrete mixtures. In some embodiments, additional additives may be used in conjunction with the powdered shrinkage compensating additives, which may improve the shrink-crack resistance of the final concrete product. In some embodiments, the additional additives may include a powdered water retention additive, such as a super absorbent polymer (SAP). Further, in some embodiments, shrinkage reduction admixtures (SRA), such as various liquid glycol type shrinkage reducing admixtures may be incorporated into central mix, truck mix, and/or volumetric mix concrete batches. Such admixture components, may be incorporated using specific sequence mixing to achieve improved crack resistance and curling resistance in the final concrete product. Further, in some embodiments, the admixture components may reduce, in some instances greatly reduce, overall shrinkage of the subsequently placed concrete product. Unique sequencing procedures utilizing aqueous slurries of mix water with the shrinkage crack preventative admixture components and subsequent mixing with solid concrete components may be utilized to achieve improved performance.

In general, the present disclosure may provide a method of forming concrete having improved the crack resistance may include providing a shrinkage reduction admixture. The method may also include providing a shrinkage compensating additive. The method may also include providing concrete solids. The method may further include mixing the shrinkage reduction admixture, the shrinkage compensating additive, and the concrete solids. For example, the individual components of the shrinkage preventing admixtures and additives may be used in connection with a truck mix, a central mix and/or a volumetric, or mobile mix. In an illustrative example, incorporation of the shrinkage preventing admixtures and additives in connection with central mix or truck mix applications may include adding mix water into the central mix drum or truck mixer and adding the liquid shrinkage reduction admixture, which may act as a dispersant or surfactant for the immediate and/or subsequent addition of a powdered shrinkage compensating additive, and/or a super absorbent polymer, when utilized. It will be appreciated that the shrinkage reduction admixture may be added to the mix drum first, and the mix water may subsequently be added, e.g., to thereby provide the pre-combining of the mix water and the shrinkage reduction admixture. As such, the shrinkage reduction admixture may be pre-combined with the mix water (e.g., prior to combining the concrete mix water with the concrete solids).

In some particular embodiments, pre-combining the shrinkage reduction admixture with the concrete mix water may produce one or more of an aqueous solution, a dispersion, and a suspension. Further, in some embodiments, the combination of the mix water with the shrinkage reduction admixture and shrinkage compensating additive (and super absorbent polymer, when utilized) may produce a temporary slurry or suspension which may be stable enough to maintain the various materials in suspension for desired time intervals. The concrete solids may then be added to the truck or central mix drum (e.g., which may include the mix water, the shrinkage reduction reagent, and the shrinkage compensating additive, as well as the super absorbent polymer, when utilized). When the completed concrete is mixed for specified proper time intervals, the crack preventative admixture formulas may be homogeneously mixed within the concrete matrix to achieve desired and/or proper field performance of the concrete product.

In some embodiments, providing the shrinkage compensating additive may include at least partially hydrating the shrinkage compensating additive with the concrete mix water. For example, as described in the above-example, the shrinkage compensating additive may be added to the mix water (e.g., which may, in some embodiments, be pre-combined with the shrinkage reduction admixture) to form a slurry or suspension, prior to the addition of the concrete solids. As such, the shrinkage compensating additive may be at least partially hydrated. It will be appreciated that, even if the shrinkage compensating additive is combined with the mix water along with, or after the addition of, the concrete solids, the shrinkage compensating additive may be at least partially hydrated by the mix water and/or the shrinkage reduction admixture. In an embodiment in which the shrinkage compensating additive may include powdered magnesium oxide, the magnesium oxide may be at least partially hydrated to produce an at least partially hydrated form of magnesium hydroxide. Further, at least partially hydrating the shrinkage compensating additive may form an at least partially hydrated slurry. In an embodiment, at least partially hydrating the shrinkage compensating additive may include mixing the shrinkage compensating additive and the concrete mix water for between about 0 minutes to about 30 minutes.

In some embodiments, another mode of incorporation for central mix or truck mix applications may include first adding mix water into the central mix drum or truck mixer, and then adding the powdered shrinkage compensation additive, as well as a super absorbent polymer, when utilized. In some embodiments, the combination of the water with the shrinkage compensating additive (and the super absorbent polymer, when utilized) may produce a temporary slurry which may be stable enough to maintain the materials in suspension for desired time intervals. It will be appreciated that, in some embodiments, the shrinkage compensating additive may be added to the mix drum first, and the mix water may subsequently be added to the mix drum to thereby pre-combine the shrinkage compensating additive and the mix water. The concrete solids may be added to the truck or central mix drum, including the mix water and the shrinkage compensating additive. The liquid shrinkage reduction admixture may be added to the mix drum after the addition (and optionally some degree of mixing) of the concrete solids. For example, in an embodiment, the liquid shrinkage reduction admixture may be added with the final batch water. When the completed concrete is mixed for specified proper time intervals, the crack preventative admixture formulas may be homogeneously mixed within the concrete matrix for achievement of desired and/or proper field performance of the resulting concrete product.

Consistent with various embodiments, the performance of the admixtures and additives in achieving the desired level of crack resistance may be improved by utilizing proper grades of each admixture or additive component. Therefore, preferred grades of each admixture or additive component will be described with preferred properties of each component below. In some embodiments, the shrinkage compensating additive may include specific grades of a lightly burned magnesium oxide (MgO) and/or other shrinkage compensating additives. Similarly, the shrinkage reduction admixture may, in some implementations, include specific glycol-based shrinkage reduction admixtures. Further, when utilized, specific grades of super absorbent polymers may be included. In some embodiments, additional components, such as water reducers, superplasticizers, and/or water repelling additives may be included.

According to some implementations, the present disclosure may be utilized in connection with different concrete production methodologies. For example, mixing the shrinkage reduction admixture, the shrinkage compensating additive, and the concrete solids may include mixing in one or more of a central mix process, a ready mix process, and a volumetric mix process. Further, in various implementations, the present disclosure may be utilized to produce various different cement or concrete products. For example, mixing the shrinkage reduction admixture, the shrinkage compensating additive, and the concrete solids may produce one or more of a grout, a mortar, a structural concrete, and a non-structural concrete.

In general, the present disclosure may be directed at methodologies for introducing groups of individual components of concrete crack preventative and/or reducing admixtures and additives into concrete batch mixing applications. The individual components of the example admixtures and/or additives may generally include a powdered grade of a shrinkage compensating additive (e.g., which may include an inorganic expansive additive such as a magnesium oxide), and a liquid grade of a shrinkage reducing admixture (e.g., which may include a glycol compound, such as a glycol ether). In some embodiments, one or more additional admixtures and/or additives may be included, such as a super absorbent polymer (e.g., which may include, for example, a polyacrylic/polyacrylamide copolymer, or the like). Various illustrative component specifications and/or chemical compositions of the admixtures and/or additives are described in greater detail below. Additionally, other concrete admixtures that can be utilized in the described methodologies may also be described.

According to an illustrative example the incorporation of a powdered shrinkage compensating additive, in the form of magnesium oxide, and a liquid shrinkage reduction admixture with concrete mix water may be sequenced to produce a stable slurry for subsequent mixing with the concrete solids in a ready mix concrete batch plant. In general, concrete solids may include solid components of a concrete mix. For example, concrete solids may include, but are not limited to, cement and one or more of course aggregate, fine aggregate, and pozzolan. Consistent with the first illustrative example, all of the concrete solids may be weighed, e.g., via computer sequencing at the ready mix batch plant. Prior to incorporating the concrete solids into the drum of a concrete mixer, a predetermined quantity of the mix water may be added to the concrete mixer. The initially added quantity of mix water added to the concrete mixer, which may be termed “head water,” may include a specified percentage of the mix water that may be determined based upon, at least in part, the plant sequencing, and the specific desired properties of the finished concrete produce.

Continuing with the first illustrative example, substantially the entire desired amount of the specified shrinkage reduction admixture (e.g., such as a glycol-based shrinkage reduction admixture) may be added to the concrete mixer drum including the head water. The shrinkage reduction admixture and head water may be mixed to form a solution or suspension. After the addition of the shrinkage reduction admixture to the head water, the specified amount of the magnesium oxide shrinkage compensating additive may be added into the premixed shrinkage reduction admixture and head water solution/suspension. In an embodiment, the magnesium oxide may be mixed with the shrinkage reduction admixture/mix water solution/suspension until the shrinkage compensating additive, shrinkage reduction admixture and mix water are well suspended. For example, the shrinkage compensating additive may be mixed with the shrinkage reduction admixture and mix water for approximately three minutes.

As mentioned above, in some embodiments the formulation may optionally include a super absorbent polymer. In such an embodiment, the shrinkage reduction admixture may be pre-combined with the concrete mix water. Further, the shrinkage compensating additive may be mixed with the pre-combined shrinkage reduction admixture and concrete mix water. The super absorbent polymer may also be mixed with the shrinkage reduction admixture, concrete mix water, and shrinkage compensating additive. In an embodiment, mixing the super absorbent polymer with the mix water, shrinkage reduction admixture, and the shrinkage compensating additive may form one or more of a slurry and a suspension, prior to mixing with the concrete solids.

Once the shrinkage reduction admixture, mix water, and shrinkage compensating additive have been mixed to form a suspension, the remaining concrete solids may be added to the suspension according to the normal sequence specified for producing the desired concrete formulation. As generally discussed above, in an example the concrete solids may include, but are not limited to cement, pozzolan, and aggregate. The cement solids and admixtures and/or additives may be mixed along with any remaining mix water (e.g., which may generally termed “tail water”). The components may be mixed together while the concrete truck is in transit to the job site.

In a second illustrative example, a powdered shrinkage compensating additive, in the form of magnesium oxide, and a liquid shrinkage reduction admixture, and, optionally, a powdered super absorbent polymer, may be incorporated into a concrete formulation using a ready mix concrete batch plant. Consistent with the second illustrative example, a pre-determined quantity of head water may be added to the concrete mixing drum. The head water may include a certain percentage of the mix water, e.g., as may be dictated by the plant sequencing according to the desired concrete formulation. A specified amount of magnesium oxide shrinkage compensating additive may be added into the head water. The magnesium oxide and head water may be mixed creating a slurry. In an embodiment, the magnesium oxide and the head water may be mixed until the magnesium oxide is well suspended. In an illustrative example, creating the desired suspension may include mixing the magnesium oxide and head water for approximately three minutes.

The remaining concrete solids may be added in the normal sequence (e.g., based upon the desired concrete formulation) until all of the concrete solids (e.g., including cement, pozzolan, aggregate and admixtures) have been added to the concrete mixing drum. Following the addition of the concrete solids, a specified amount of the liquid shrinkage reduction admixture (e.g., which may include a glycol-based shrinkage reduction admixture) may be added into the concrete mixing drum along with the tail water. The mix, including all components, may be mixed while the concrete truck is in transport to the job site.

In a third illustrative example, a powdered shrinkage compensating additive, in the form of powdered magnesium oxide, a liquid shrinkage reduction admixture, in the form of a liquid glycol-based shrinkage reduction admixture, and, optionally, a powdered super absorbent polymer may be incorporated into a concrete mixture in a volumetric/mobile batch mixer. Consistent with the third illustrative example, all of the materials required for the concrete mixture may be loaded into the volumetric mixer. Consistent with the illustrative example, the cement solids (e.g., aggregates, cementitious material, pozzolan, etc.) may be placed in separate bins within the volumetric batch mixer. Similarly, the powdered magnesium oxide shrinkage compensating additive may also be placed in a separate bin. The water tank may be filled with mix water, and the liquid glycol-based shrinkage reduction admixture may be stored in a separate tank.

To form the concrete mixture, the conveyor of the volumetric mixer may be started, and the auger may then initiate discharge. The cement, pozzolan, and powdered magnesium oxide shrinkage compensating additive may be metered at a pre-determined rate into the auger with the aggregate (e.g., which may include both coarse and fine aggregate) at pre-determined rates based upon, at least in part, the formulation for the specific concrete material to be produced. The water and other liquid components, including the glycol-based liquid shrinkage reducing admixture, may be discharged into the auger at specific pre-determined rates based upon, at least in part, the formulation for the specific concrete material to be produced. The auger may homogeneously mix all of the material in the time that it takes for the material to reach the discharge end of the auger.

In a fourth illustrative example, powdered magnesium oxide as a shrinkage compensating additive, a liquid shrinkage reduction admixture, and, optionally, a super absorbent polymer, maybe incorporated into a concrete product also using a volumetric/mobile mixer, as in the previous example. In the fourth illustrative example, the various required materials may be loaded into the volumetric mixer. For example, the aggregates in separate bins. All of the cementitious material may also be placed in separate bins within the volumetric/mobile mixer. Further, the water tank may be filled with mix water and with the proper amount of liquid shrinkage reducing admixture (e.g., which may include a glycol-based shrinkage reduction admixture), thereby creating an aqueous solution. Any other required liquid components may be placed in respective tanks within the volumetric/mobile mixer.

The conveyor and the auger may be started, and discharge may be initiated. The cement, pozzolan and magnesium oxide shrinkage compensating additive may be metered at a pre-determined rate (e.g., based upon a specified formulation for the desired concrete product) into the auger along with the aggregate, both coarse and fine, at pre-determined rates. The aqueous solution of the mix water and the glycol-based shrinkage reducing admixture, as well as any other liquid components, may be discharged into the auger at specific pre-determined rates, based upon, at least in part, a formulation for the desired concrete product. The auger may homogeneously mix all of the material in the time it takes for the material to reach the discharge end of the auger.

According to various embodiments, between about 7% to about 25% by weight of shrinkage reduction admixtures may be included based on the amount of shrinkage compensating additive. In further embodiments, between about 17.5% to about 25% by weight of shrinkage reduction admixture may be included based upon the amount of shrinkage compensating additive. Further, in an embodiment, a super absorbent polymer may be added to the shrinkage reduction admixture shrinkage compensating additive (e.g., which may be combined with the mix water within the ready mix or central mix barrels). For example, in some embodiments the super absorbent polymer may provide further improvements to the overall concrete mix in terms of shrinkage crack prevention (e.g., particularly in instances where relatively low water to cement ratios are specified in the design mix). An example range of super absorbent polymer may be between about 0% to about 7% by weight based on the amount of shrinkage compensating additive. At water to cementitious ratios less than or equal to 0.38, the super absorbent polymer may be provided in the range of between about 0.1% to about 12% by weight based on the amount of shrinkage compensating additive.

According to some example embodiments of the present disclosure, the shrinkage compensating additive may include magnesium oxide. Other expansion products (e.g., shrinkage compensating additives) may be used with the magnesium oxide, and/or as a replacement for the magnesium oxide. As such, the shrinkage compensating additive may additionally and/or alternatively include one or more of calcium oxide, calcium silicate, calcium sulfa aluminate, magnesium silicate, magnesium hydroxide, and magnesium sulfa aluminate.

According to a specific illustrative example, the shrinkage compensating additive may include a low temperature calcined and reactive magnesium oxide calcined at a temperature in the range of between about 750° C. to about 1,200° C. That is, for example, the example magnesium oxide may be produced by heating magnesium carbonate (e.g., Magnesite) to a temperature in the range of approximately between 750° to 1200° C. Further, the shrinkage compensating additive may include magnesium oxide having a mean particle size in the range from between about 10 micrometers to about 20 micrometers.

In some embodiments, the shrinkage reduction admixture may include a surface reducing additive. Generally, the shrinkage reduction admixture may include one or more of a glycol ether, a polyglycol, a polypropylene glycol, a polyethylene glycol, and a glycol ether derivative. For example, shrinkage reduction admixtures that may be suitable for use in in connection with the present disclosure may include shrinkage reduction admixtures such as those disclosed in one or more of U.S. Pat. Nos. 5,556,460; 5,618,344; 5,779,788; 5,603,760; 5,622,558 and 6,277,191, which are incorporated herein by reference. Particular suitable shrinkage reduction admixture that may be used in connection with the present disclosure may include, but are not limited to, an alkylene glycol represented by the general formula HOBOH wherein B represents a C3-C12 alkylene group, such as a Cs-Cg alkylene group. Examples of such glycols may include 1,6-hexanediol, 1,5-pentanediol, 1,4-pentanediol, 2-methyl-2,4-pentanediol and the like. As another example, a shrinkage reduction admixture may include a diol, such as a secondary and/or tertiary dihydroxy C3-C8 alkane, represented by the formula:

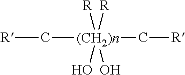

Wherein each R independently represents a hydrogen atom or a C1-C2 alkyl group, each R′ represents a C1-C2 alkyl group, and n represents an integer or 1 or 2. Of the diol-based SRAs, the most preferred is 2-methyl-2,4-pentadiol, which is sometimes referred to as “hexylene glycol” (“HG”).

Consistent with some implementations, alkylene glycols that may be useful may include, for example, condensed alkylene glycols represented by the formula HO(AO)xH wherein A represents a propylene and more preferably an ethylene or methylene; O represents an oxygen atom; and x is an integer in the range of approximately 1 to 10, provided the diol is soluble in water. The AO group in a particular glycol molecule may all be the same or different. Examples of such glycols include diethylene glycol, dipropylene glycol, tripropylene glycol, di(oxyethylene), di(oxypropylene)glycol as well as poly(oxyalkylene)glycols. The AO groups of such polyoxyalkylene glycols may be of single alkylene or a mixture of alkylene groups which are either block or random configuration.

As mentioned above, in some embodiments, a super absorbent polymer may be mixed with the shrinkage reduction admixture, the shrinkage compensating additive, and the concrete solids. The super absorbent polymer may include one or more of a cellulosic material, a fiber-based material, a starch, a polyacrylonitrile, a polyvinyl alcohol, a carboxymethyl cellulose, an isobutylene maleic anhydride, a polyacrylic, and a polyacrylamide included as one or more of a single polymer, a co-polymer, a tertiary polymer, and a cross-linked polymer in an acrylic-acrylamide copolymer system neutralized with one or more of potassium, magnesium, and another alkali earth metal. The super absorbent polymer may be a solid, a liquid , and/or may be part of an emulsion. In some embodiments, super absorbent polymers may include cross-linked acrylic-acrylamide copolymers neutralized with potassium, magnesium or other alkali earth metals. When in solid form, the super absorbent polymer may have a particle size in the range of between about 75 micrometers to about 2000 micrometers.

According to various illustrative examples, additions by mass of the cement admixture or additive, when the water-to-cementitious ratio is at or below, for example, 0.38 may be as follows:

| | Range | Preferred Range |
|---|---|---|
| Component | (% on Cementitious) | (% on Cementitious) |
| MgO | 3.0 to 8.0 | 3.75 to 7.5 |
| SRA | 0.5 to 2.0 | 0.5 to 1.75 |
| SAP | 0 to 0.4 | 0.1 to 0.3 |

In an illustrative embodiment, a useful range for the shrinkage compensating additive (e.g., which may include magnesium oxide) and the shrinkage reduction admixture may include between about 7% to about 30% of the shrinkage reduction admixture by mass of the shrinkage compensating additive. In another illustrative embodiment, the range for the shrinkage compensating additive and shrinkage reduction admixture may be between about 13% to about 25% shrinkage reduction admixture by mass of the shrinkage compensating additive. In still a further illustrative example, the range for the shrinkage compensating additive and the shrinkage reduction admixture may be between about 17.5% to about 25% shrinkage reduction admixture by mass of shrinkage compensating additive.

In an illustrative embodiment including a dry super absorbent polymer, in combination with the shrinkage reduction admixture and the shrinkage compensating additive, between about 0% to about 7% by mass of dry super absorbent polymer may be included based on the shrinkage compensating additive content. In a further illustrative example, for concrete mixtures having water-to-cementitious ratios less than or equal to 0.38%, between about 2 to about 7% by mass of dry super absorbent polymer may be added based on the shrinkage compensating additive content.

In addition to the above-discussed admixtures and/or additives, various additional components may be included. For example, one or more water repelling additives, or early age desiccation additives, may be included. Examples of suitable water repelling additives that can be used in embodiments of the present disclosure may include, but are not limited to, calcium or butyl stearates or oleates, polymer stearates, potassium methyl siliconate, and organo-silane derivatives. The water-to-binder (cementitious) ratio in illustrative embodiments of the present disclosure may be in the range of approximately between 0.20 to 0.65. All of the components may help to offset shrinkage at the lower ratios, and at the higher ratios deleterious expansions over 0.1% in 28 days of moisture exposure for mortars or 0.04% of moisture induced expansion for concretes may generally not be exceeded.

In some implementations, water reducing and/or superplasticizing admixtures or additives may be utilized in conjunction with the shrinkage reduction admixtures and shrinkage compensating additives. Illustrative example of suitable water reducers and superplasticizers may include, but are not limited to, modified lignosulfonates, polycarboxylate derivatives, sulfonated melamine-formaldehyde condensates, and sulfonated naphthalene-formaldehyde condensates.

A number of implementations have been described. Nevertheless, it will be understood that various modifications may be made. Accordingly, other implementations are within the scope of the following claims.

1. A method of forming concrete having improved the crack resistance, the method comprising:
providing a shrinkage reduction admixture, including pre-combining the shrinkage reduction admixture with concrete mix water;
providing a shrinkage compensating additive, including combining the shrinkage compensating additive with the pre-combined shrinkage reduction admixture and concrete mix water;
providing concrete solids; and
mixing the shrinkage reduction admixture, and the shrinkage compensating additive, being pre-combined with the concrete mix water, with the concrete solids.

2. (canceled)

3. The method of claim 1, wherein pre-combining the shrinkage reduction admixture with the concrete mix water produces one or more of an aqueous solution, a dispersion, and a suspension.

4. (canceled)

5. The method of claim 1, wherein providing the shrinkage compensating additive includes at least partially hydrating the shrinkage compensating additive with the concrete mix water.

6. The method of claim 5, wherein at least partially hydrating the shrinkage compensating additive comprises mixing the shrinkage compensating additive and the concrete mix water for between about 0 minutes to about 30 minutes.

7. The method of claim 1, wherein the shrinkage reduction admixture includes a surface tension reducing additive.

8. The method of claim 6, wherein the shrinkage reduction admixture comprises one or more of a glycol ether, a polyglycol, a polypropylene glycol, a polyethylene glycol, and a glycol ether derivative.

9. The method of claim 1, wherein the shrinkage compensating additive comprises one or more of magnesium hydroxide, magnesium oxide, calcium oxide, calcium silicate, calcium sulfa aluminate, magnesium silicate, and magnesium sulfa aluminate.

10. The method of claim 1, wherein the shrinkage compensating additive comprises a low temperature calcined and reactive magnesium oxide calcined at a temperature in the range of between about 750° C. to about 1,200° C.

11. The method of claim 1, wherein the shrinkage compensating additive comprises magnesium oxide having a mean particle size in the range from between about 10 micrometers to about 20 micrometers.

12. The method of claim 1, wherein the concrete solids comprises cement and one or more of course aggregate, fine aggregate, and pozzolan.

13. The method of claim 1, wherein mixing the shrinkage reduction admixture, the shrinkage compensating additive, and the concrete solids includes mixing in one or more of a central mix process, a ready mix process, and a volumetric mix process.

14. The method of claim 1, wherein mixing the shrinkage reduction admixture, the shrinkage compensating additive, and the concrete solids produces one or more of a grout, a mortar, a structural concrete, and a non-structural concrete.

15. The method of claim 1, further comprising mixing a super absorbent polymer with the shrinkage reduction admixture, the shrinkage compensating additive, and the concrete solids.

16. The method of claim 15, wherein the super absorbent polymer comprises one or more of a cellulosic material, a fiber-based material, a starch, a polyacrylonitrile, a polyvinyl alcohol, a carboxymethyl cellulose, an isobutylene maleic anhydride, a polyacrylic, and a polyacrylamide includes as one or more of a single polymer, a co-polymer, a tertiary polymer, and a cross-linked polymer in an acrylic-acrylamide copolymer system neutralized with one or more of potassium, magnesium, and another alkali earth metal.

17. The method of claim 15, wherein mixing the super absorbent polymer with the shrinkage reduction admixture, the shrinkage compensating additive, and the concrete solids comprises:
pre-combining the shrinkage reduction admixture with concrete mix water;
mixing the shrinkage compensating additive with the pre-combined shrinkage reduction admixture and concrete mix water; and
mixing the super absorbent polymer with the mixed shrinkage reduction admixture, concrete mix water, and shrinkage compensating additive to form one or more of a slurry and a suspension prior to mixing with the concrete solids.

18. The method of claim 1, further comprising mixing an early-age desiccation additive with the shrinkage reduction admixture, the shrinkage compensating additive, and the concrete solids, the early-age desiccation additive comprising one or more of a calcium stearate, a butyl stearate, a polymer stearate, a potassium methyl siliconate, and an organo-silicone derivative.

19. The method of claim 1, further comprising mixing one or more of a polycarboxylate derivative, a sulfonated melamine-formaldehyde condensate, a sulfonated naphthalene-formaldehyde condensate, and a modified lignosulfonate with the shrinkage reduction admixture, the shrinkage compensating additive, and the concrete solids.
